(19) United States
(12) Patent Application Publication
(10) Pub. No.: US 2026/0112841 A1
(43) Pub. Date: Apr. 23, 2026

(54) DEVICE ADAPTER AND ELECTRICAL CONNECTOR THEREOF

(71) Applicant: Amphenol Commercial Products (Chengdu) Co., Ltd., Chengdu (CN)

(72) Inventors: Xingrui Yang, Chengdu (CN); Chao Zou, Chengdu (CN); Yaohua Hou, Chengdu (CN); Koen Maddens, Hofstade (BE); Ki Ka Lau, Kowloon (HK)

(73) Assignee: Amphenol Commercial Products (Chengdu) Co., Ltd., Chengdu (CN)

(21) Appl. No.: 19/353,787

(22) Filed: Oct. 9, 2025

(30) Foreign Application Priority Data
Oct. 17, 2024 (CN) 202422518922.3
Nov. 20, 2024 (CN) 202411666840.1
Nov. 20, 2024 (CN) 202422836517.6

(51) Int. Cl. H01R 13/516

(52) U.S. Cl. CPC H01R 13/516

(57) ABSTRACT

Device adapters and electrical connectors thereof that enable quick connection and release of devices with connectors while maintaining or improving connection reliability. An adapter is configured for fixedly disposed on a device. The device has a mating face and a card edge configured for mating with a connector. The adapter comprises a body disposed on a top of the device and extending beyond the mating face of the device so as to insert into an upper slot of an outer housing of the connector. The adapter comprises a latch movably connected to the body and configured for locking and unlocking from the connector. The outer housing of the connector includes the upper slot and a lower slot stacked below the upper slot and holding an inner housing therein. The inner housing holds conductive elements and has a slot configured for receiving the card edge of the device.

### CROSS-REFERENCE TO RELATED APPLICATIONS

This application claims priority to and the benefit of Chinese Patent Application No. 202411666840.1, filed on Nov. 20, 2024. This application also claims priority to and the benefit of Chinese Patent Application No. 202422836517.6, filed on Nov. 20, 2024. This application also claims priority to and the benefit of Chinese Patent Application No. 202422518922.3, filed on Oct. 17, 2024. The contents of these applications are incorporated herein by reference in their entirety.

### FIELD

This disclosure relates generally to interconnection systems, such as those including electrical connectors, used to interconnect electronic assemblies.

### BACKGROUND

An electronic system (e.g., smart phone, tablet computer, desktop computer, digital camera) may be manufactured as a collection of separate electronic assemblies that are joined with electrical connectors. For example, a known architecture of an electronic system has a printed circuit board (PCB), sometimes called a mother board, to which are mounted many electronic components. For example, in a server, the motherboard may contain a processor and supporting chips. Other electronic components, such as solid state memories, may be mounted on a separate PCB, sometimes called a daughter card. The daughter card may be inserted into a port of a connector mounted to the motherboard for interconnection with the electronic components on the motherboard.

### SUMMARY

Aspects of the present disclosure relate to device adapters and electrical connectors thereof.

Some embodiments relate to an adapter configured for attachment to a device so as to mechanically support the device when the device is connected to an electrical connector. The adapter may include a body comprising a rear portion configured for engaging a top of the device and a tongue extending from the rear portion; a latch comprising a beam having a proximal end connected to the tongue of the body and a distal end opposite the proximal end; and an arm connected to the rear portion of the body and configured for attachment to a corner of the device.

Optionally, the adaptor comprises a bridge connected to the rear portion of the body and comprising a portion disposed above the rear portion of the body, wherein the beam is movably disposed between the body and the portion of the bridge disposed above the rear portion of the body.

Optionally, the beam comprises a protrusion having a slanted surface.

Optionally, the beam comprises a first portion and a second portion disposed closer to the portion of the bridge disposed above the rear portion of the body than the first portion; and the second portion is t-shaped.

Optionally, the beam is a first beam; and the latch comprises a second beam having a proximal end connected to the tongue of the body and a distal end opposite the proximal end, and a channel between the first beam and the second beam.

Optionally, the second beam is symmetrical with the first beam; and the latch comprises a bar connecting the distal ends of the first and second beams.

Optionally, the arm comprises a first portion extending beyond the rear portion of the body, and a second portion having an opening configured to receive a fastener.

Optionally, the arm comprises a transition portion joining the first portion and the second portion.

Optionally, the first portion of the arm comprises a projection protruding toward the body.

Optionally, the tongue of the body comprises a mating portion configured to engage with the device.

Some embodiments relate to an electrical connector. The electrical connector may include an outer housing comprising an upper slot, a lower slot, and an extension extending beyond the lower slot in a mating direction; an inner housing disposed in the lower slot of the outer housing and comprising a slot; and a plurality of conductive elements disposed in the inner housing, each of the plurality of conductive elements comprising a mating end disposed in the slot of the inner housing, a tail portion, and an intermediate portion between the mating end and the tail portion.

Optionally, the extension comprises at least one projection elongated in the mating direction and protruding into the upper slot.

Optionally, the extension comprises a pair of holes and a pair of protrusions protruding downwardly and adjacent respective ones of the pair of holes; and the at least one projection is disposed between the pair of protrusions.

Optionally, the tail portions of the plurality of conductive elements comprises surfaces configured for mounting to a circuit board.

Optionally, the surfaces of the tail portions of the plurality of conductive elements extending in parallel to the mating direction.

Optionally, the electrical connector further comprises a plurality of cables comprising wires attached to the tail portions of the plurality of conductive elements.

Optionally, the electrical connector further comprises a member comprising a lower portion disposed in an opening of the outer housing and an upper portion disposed in a groove of the inner housing.

Optionally, the upper portion of the member is shaped to restrain relative movements between the inner housing and the outer housing.

Optionally, the outer housing comprises a side extension configured to abut a mating face of a mating device.

Some embodiments relate to a method of operating an adapter configured to mechanically support a device when the device is connected to an electrical connector. The method may include providing a device comprising a top, bottom, side joining the top and bottom, and a mating face at a front; and installing the adapter on the device comprising disposing a body of the adapter on the top of the device such that a portion of the body of the adapter extends beyond the mating face of the device.

Optionally, the body of the adapter comprises a rear portion and a tongue extending from the rear portion; and the tongue comprises the portion of the body of the adapter that extends beyond the mating face of the device.

Optionally, the adapter comprises an arm connected to the rear portion of the body, each of the body and arm comprising one or more projections; each of the top and side of the device comprising one or more grooves; and installing the adapter on the device comprising disposing the one or more projections of the body and arm of the adapter in the one or more grooves of the top and side of the device, respectively.

Optionally, the method further comprises inserting a fastener through an opening of the arm of the adapter into an opening at the top of the device.

Optionally, installing the adapter on the device comprises engaging a rear face of the portion of the body of the adapter that extends beyond the mating face of the device with the mating face of the device.

Optionally, the device comprises a card edge extending beyond the mating face of the device and parallel to the portion of the body of the adapter that extends beyond the mating face of the device.

Optionally, the method further comprises providing a connector, which comprises an outer housing having an upper slot, a lower slot, and an extension extending beyond the lower slot in a mating direction, and an inner housing disposed in the lower slot of the outer housing; and mating the device with the connector comprising inserting the tongue of the adapter into the upper slot of the outer housing of the connector.

Optionally, the adapter comprises first and second beams having proximal ends connected to the tongue of the body and distal ends disposed above the rear portion of the body, and a channel between the first and second beams; the extension of the connector comprising a projection elongated in the mating direction and protruding into the upper slot; and inserting the tongue of the adapter into the upper slot of the outer housing of the connector comprises inserting the projection of the extension of the outer housing of the connector into the channel between the first and second beams of the adapter.

Optionally, the first and second beams of the adapter each comprises a protrusion protruding upwardly; and inserting the tongue of the adapter into the upper slot of the outer housing of the connector comprises at least partially disposing the protrusions of the first and second beams of the adapter in respective holes at the top of the extension of the outer housing of the connector.

Optionally, the method further comprises unmating the device from the connector comprising pressing the first and second beams of the adapter so as to disengage the protrusions of the first and second beams from the respective holes at the top of the extension of the outer housing of the connector.

Some embodiments relate to an electronic system. The electronic system may include a device comprising a mating face and a card edge adjacent the mating face; and an adapter fixedly disposed on the device and comprising a mating portion having a rear face abutting the mating face of the device.

Optionally, the adapter further comprises a body comprising a tongue comprising the mating portion, and a rear portion; and an arm connected to the rear portion and attached to a corner of the device.

Optionally, the arm engages with a top and a side of the device.

Optionally, the electronic system further comprises a fastener extending through an opening of the adapter into an opening of the device.

Optionally, the arm comprises a projection protruding toward the body; the body comprises a projection protruding downwardly; and the device comprises a first groove recessed from a side of the device and configured to receive the projection of the arm, and a second groove recessed from a top of the device and configured to receive the projection of the body.

Optionally, the adapter further comprises a latch comprising first and second beams connected to the mating portion of the body of the adapter at proximal ends and comprising first and second projections upwardly, respectively, and a channel between the first beam and the second beam.

Optionally, the electronic system further comprises a connector comprising an outer housing comprising an upper slot, a lower slot, and an extension extending beyond the lower slot, the extension comprising a projection protruding into the upper slot and configured to fit in the channel of the latch.

Optionally, the card edge extends beyond the mating face.

Optionally, the electronic system further comprises a connector mated with the device, the connector comprising an outer housing having an upper slot, a lower slot, and an extension extending beyond the lower slot in a mating direction; an inner housing disposed in the lower slot of the outer housing; and a plurality of conductive elements disposed in the inner housing and configured to contact with contact pads on the card edge of the device.

Optionally, the extension of the outer housing of the connector comprises a projection disposed in the channel between the first and second beams of the latch of the adapter.

Optionally, the extension of the outer housing of the connector comprises a pair of holes and a pair of protrusions protruding downwardly adjacent respective ones of the pair of holes; the pair of protrusions are disposed on opposite sides of the projection disposed in the channel between the first and second beams of the latch of the adapter; and the first and second beams of the latch of the adapter comprise protrusions protruding toward respective ones of the pair of holes of the extension of the outer housing of the connector and abut against respective ones of the pair of protrusions disposed on the opposite sides of the projection.

These techniques may be used alone or in any suitable combination. The foregoing summary is provided by way of illustration and is not intended to be limiting.

### BRIEF DESCRIPTION OF DRAWINGS

The accompanying drawings may not be drawn to scale. In the drawings, each identical or nearly identical component that is illustrated in various figures may be represented by a like numeral. For purposes of clarity, not every component may be labeled in every drawing. In the drawings:

FIG. 1A is a front perspective view of an electronic system, according to some embodiments.

FIG. 1B is a partially exploded perspective view of the electronic system of FIG. 1A.

FIG. 2A is a top, front perspective view of an adapter of the electronic system of FIG. 1A.

FIG. 2B is a rear, bottom perspective view of the adapter of FIG. 2A.

FIG. 2C is a top view of the adapter of FIG. 2A.

FIG. 2D is a front, side perspective view of the adapter of FIG. 2A.

FIG. 2E is a side view of the adapter of FIG. 2A.

FIG. 2F is a front view of the adapter of FIG. 2A.

FIG. 3A is a front perspective view of the electronic system of FIG. 1A, with a board connector hidden, showing an adapter installed on a solid state drive (SSD).

FIG. 3B is a partially exploded perspective view of the electronic system of FIG. 3A, showing the adapter and the SSD, respectively.

FIG. 3C is a rear view of the electronic system of FIG. 3B.

FIG. 4A is a top, front perspective view of the board connector of the electronic system of FIG. 1A.

FIG. 4B is a front view of the board connector of FIG. 4A.

FIG. 4C is a rear perspective view of the board connector of FIG. 4A.

FIG. 4D is a bottom perspective view of the board connector of FIG. 4A.

FIG. 5A is a partially exploded perspective view of the board connector of FIG. 4A.

FIG. 5B is a front view of the board connector of FIG. 5A.

FIG. 5C is a side view of the board connector of FIG. 5A.

FIG. 6 is a cross-sectional perspective view of the board connector of FIG. 4A along a line marked “6-6” in FIG. 4D.

FIG. 7 is a partially exploded perspective view of an electronic system, according to some embodiments.

FIG. 8A is a top, front perspective view of a cable connector of the electronic system of FIG. 7.

FIG. 8B is a bottom, front perspective view of the cable connector of FIG. 8A.

FIG. 8C is a front view of the cable connector of FIG. 8A.

FIG. 8D is a bottom, front perspective view of the cable connector of FIG. 8A.

FIG. 8E is a cross-sectional perspective view of the cable connector of FIG. 8A along a line marked “8E-8E” in FIG. 8D.

FIG. 9A is a partially exploded perspective view of the cable connector of FIG. 8A.

FIG. 9B is a partially exploded side view of the cable connector of FIG. 8A.

FIG. 9C is a partially exploded bottom, front perspective view of the cable connector of FIG. 8A.

### DETAILED DESCRIPTION

The inventors have recognized and appreciated techniques for quick connection and release of a device with a connector while maintaining or improving the reliability of the connection. Conventionally, some device may require additional mounting structures when connected to a connector. Exemplary devices include, but are not limited to, solid state drives (SSD), wireless communication cards, and radio frequency modules. These additional mounting structures often require specific tools in the field and can increase installation time. According to aspects of the present disclosure, an adapter may be configured for attachment to a device such that the device can mate and unmate with an electrical connector quickly and reliably without the use of specific tools. The adapter may mechanically support the device when the device is connected to an electrical connector. The electrical connector may have features configured to facilitate a reliable connection.

According to aspects of the present disclosure, an adapter may be configured for fixedly disposed on a device. The device may include a mating face and a card edge adjacent the mating face and having contact pads configured for contacting conductive elements of an electrical connector. The adapter may include a body disposed on a top of the device. The body may include a rear portion and a tongue extending from the rear portion and beyond the mating face of the device. The portion of the tongue that extends beyond the mating face of the device may have a rear face configured for abutting the mating face of the device. In some embodiments, the adapter may include an arm connected to the rear portion of the body and configured for attachment to a corner of the device. The body and arm each may include one or more projections configured for disposing in respective grooves recessed from the top and sides of the device, respectively. In some embodiments, the arm may include an opening through which a fastener may extend into an opening of the device so as to further secure the adapter to the device.

In some embodiments, the adapter may include a latch movably connected to the body and configured for locking and unlocking from a connector. The latch may include one or more beams having a proximal end connected to the tongue of the body and a distal end opposite the proximal end. One or more beams may include protrusions protruding upwardly and away from the body of the adapter and configured for protruding into respective receivers of a mating connector. The distal ends of the one or more beams may be configured for releasing the protrusions from the receivers of the mating connector when pressed. Optionally, the distal ends of the one or more beams may be joined by a bar. The adapter may include a channel between adjacent beams. The adapter may include a bridge disposed above and connected to the rear portion so as to restrain the movements of the latch.

According to aspects of the present disclosure, an electrical connector may include an outer housing having an upper slot, a lower slot stacked below the upper slot, and an extension extending beyond the lower slot in a mating direction. The electrical connector may include an inner housing disposed in the lower slot of the outer housing. The inner housing may hold a plurality of conductive elements. A member may be configured for reducing the risk of relative movements between the outer housing and the inner housing. In some embodiments, the member may include a lower portion disposed in an opening of the outer housing and an upper portion disposed in a groove of the inner housing. The lower portion and upper portion of the member may be shaped to restrain the relative movements between the inner and outer housing. The conductive elements may be configured for mounting to a circuit board and/or attachment with cables.

In some embodiments, the extension of the outer housing may include one or more projections elongated in the mating direction and protruding into the upper slot. A projection may be configured for disposing in the channel between adjacent beams of the latch of the adapter. The top of the extension of the outer housing may include the receivers (e.g., holes) of the protrusions of the beams. The top of the extension of the outer housing may include protrusions adjacent the receivers and configured for abutting the protrusions of the beams so as to reduce the risk of the protrusions of the beams from accidentally disengaging the receivers.

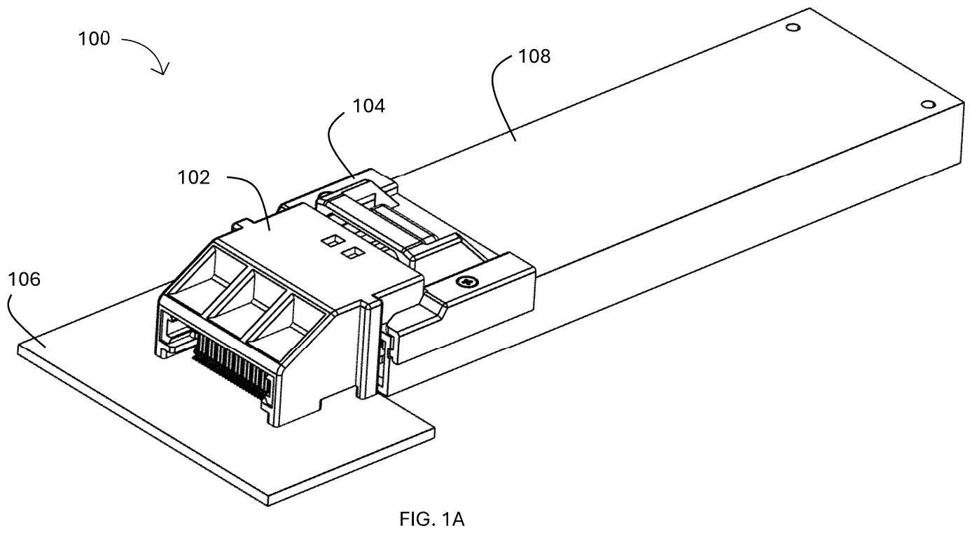

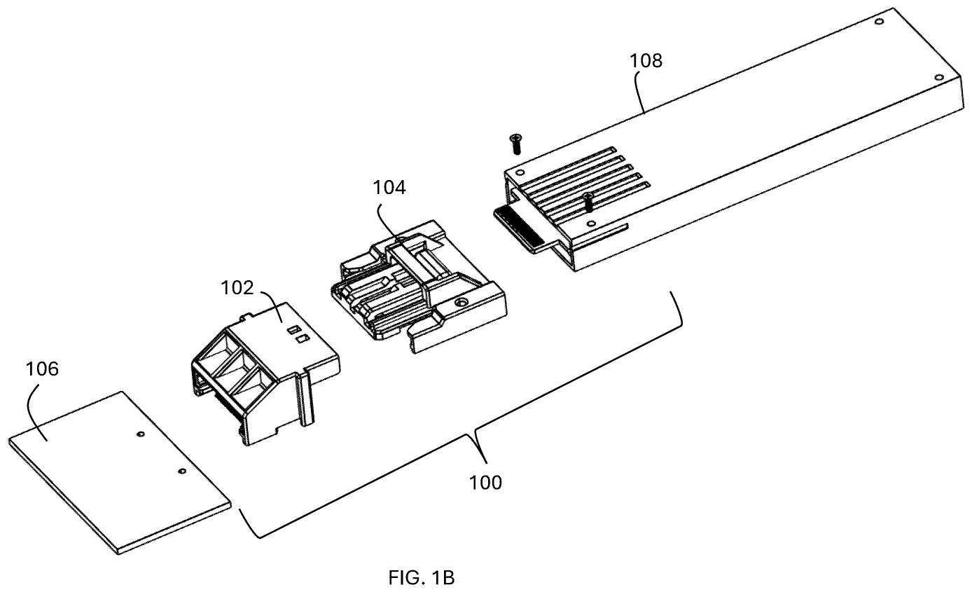

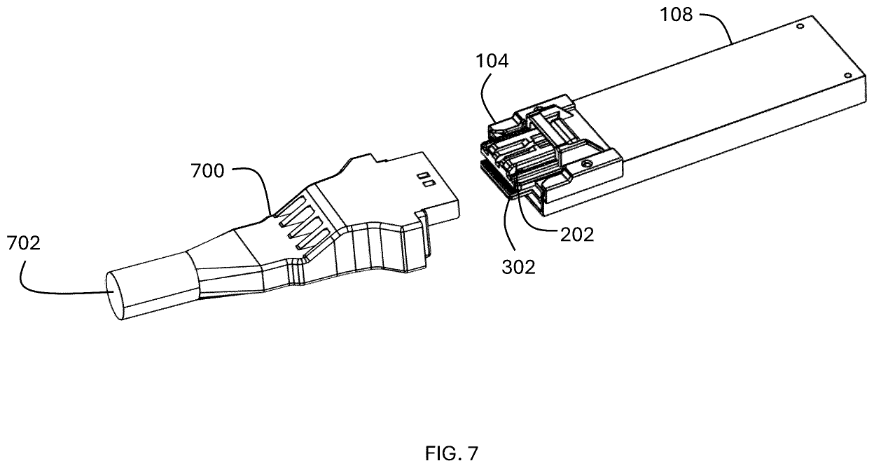

FIGS. 1A and 1B illustrate a front perspective view and a partially exploded perspective view of an electronic system 100, respectively, according to some embodiments. The electronic system 100 may include device 108, adapter 104 attached to device 108, and connector 102 configured to engage with device 108 attached with adapter 104. In this example, connector 102 may be a board connector that is configured to engage with a circuit board such as a motherboard. Only a portion of the motherboard is shown; and other components that may be mounted on motherboard, such as a processor, are not shown. Alternatively or additionally, connector 102 may be a cable connector that is configured to engage with a cable, as described later in connection with FIGS. 7-9. The cable may be, but is not limited to, a fiber optic cable, USB cable, HDMI cable, twisted pair cable, and/or a coaxial cable. Adapter 104 may be configured to engage with a device 108. As shown in the illustrated example, the device 108 may be a solid state drive (SSD). Alternatively or additionally, add-in cards such as wireless communication cards and/or radio frequency modules may be used, for example. For example, the adapter 104 may enable a direct connection between connector 102 and device 108, provide mechanical support for the device 108, and simplify the process of assembling an electronic system.

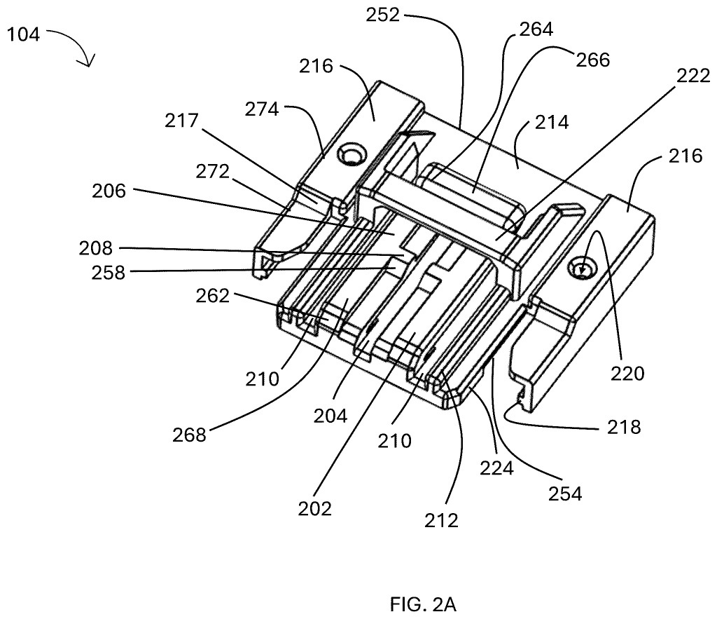

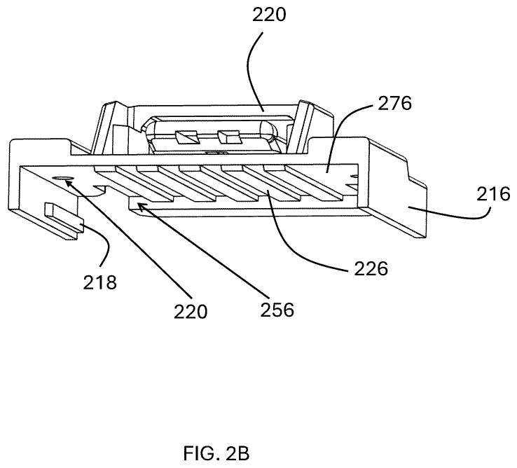

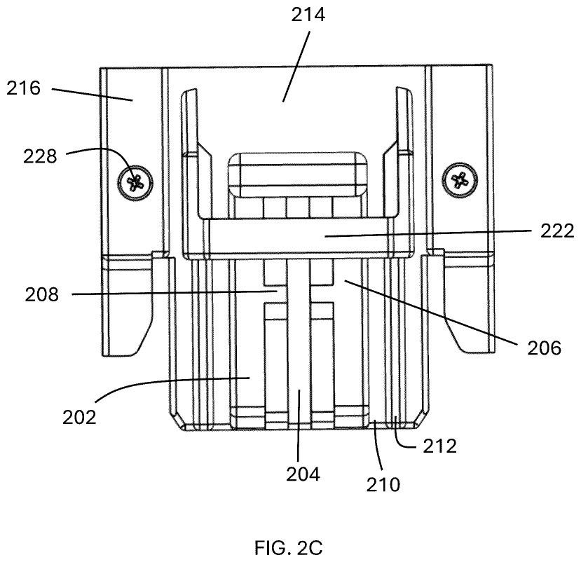

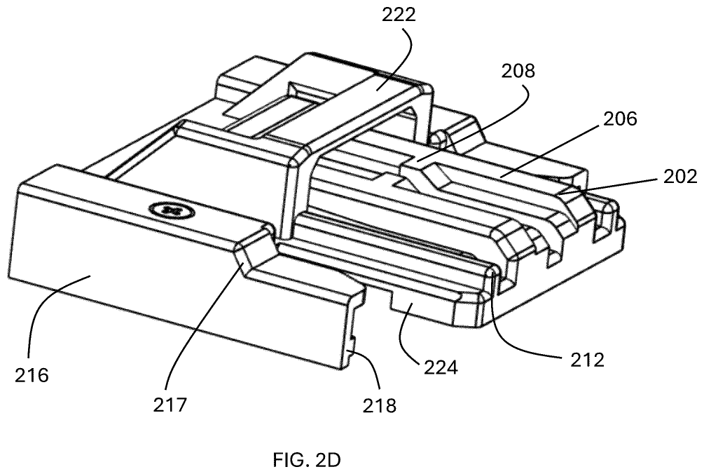

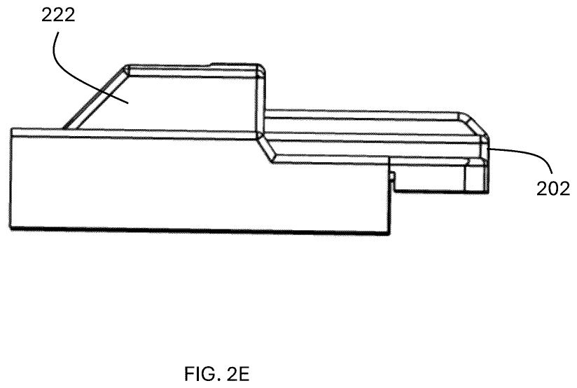

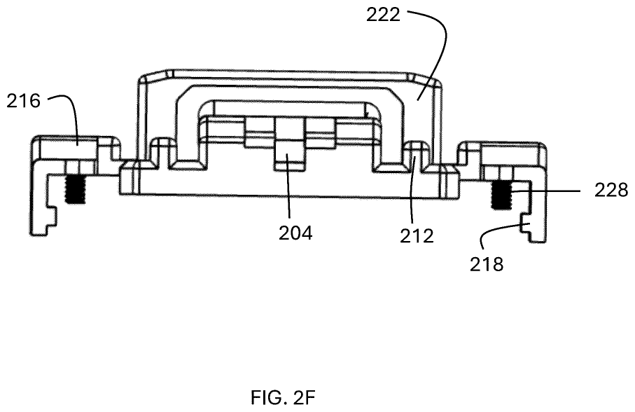

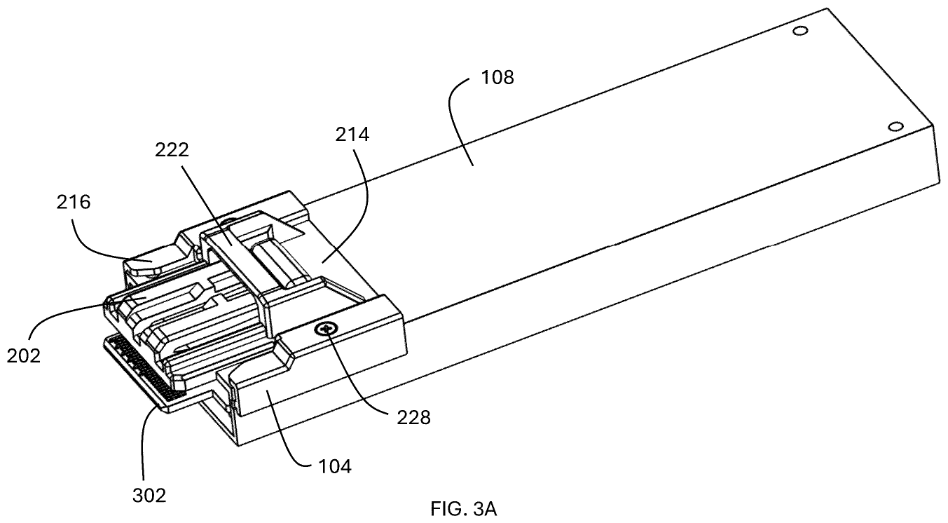

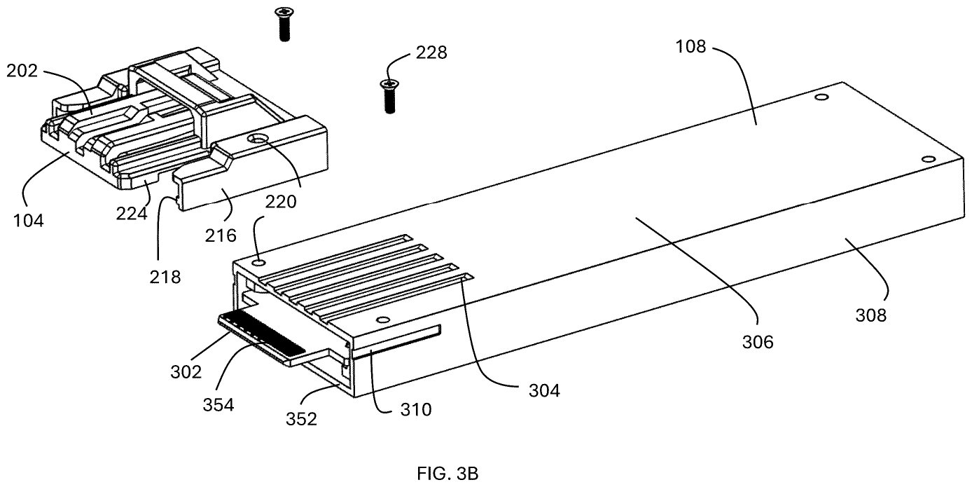

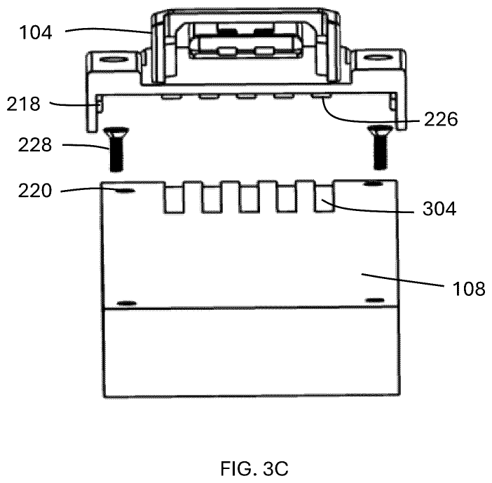

FIGS. 2A-2F and FIGS. 3A-3C illustrate various views of adapter 104 and adapter 104 installed on device 108, respectively. The device 108 may include a mating face 352 and a card edge 302. The card edge 302 extends beyond the mating face 352. The card edge 302 is adjacent the mating face 352 and has contact pads 354 configured for contacting conductive elements of connector 102. The adapter 104 may include a body 214 disposed on a top of the device 108. The body 214 may include a rear portion 252 and a tongue 254 extending from the rear portion 252 and beyond the mating face 352 of the device 108. The rear portion 252 is configured for engaging a top of the device 108. The mating portion 224 of the tongue 254 that extends beyond the mating face 352 of the device 108 may have a rear face 256 configured for abutting the mating face 352 of the device 108. In some embodiments, the adapter 104 may include an arm 216 connected to the rear portion 252 of the body 214 and configured for attachment to a corner of the device. The body 214 and arm 216 each may include one or more projections configured for disposing in respective grooves recessed from the top and sides of the device, respectively. In some embodiments, the arm 216 may include an opening 220 through which a fastener 228 may extend into an opening 220 of the device 108 so as to further secure the adapter to the device. In some embodiments, the electronic system may include an engagement feature such as a fastening assembly. Each respective opening 220 of adapter 104 may align with a respective opening 220 of device 108.

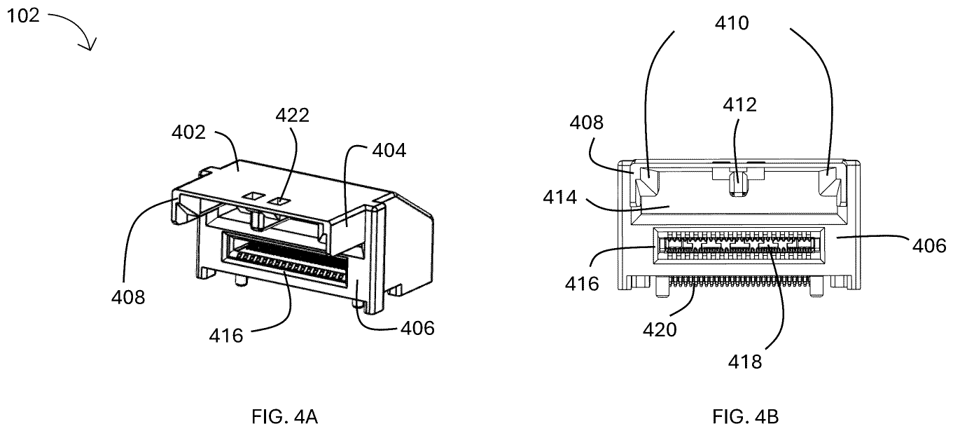

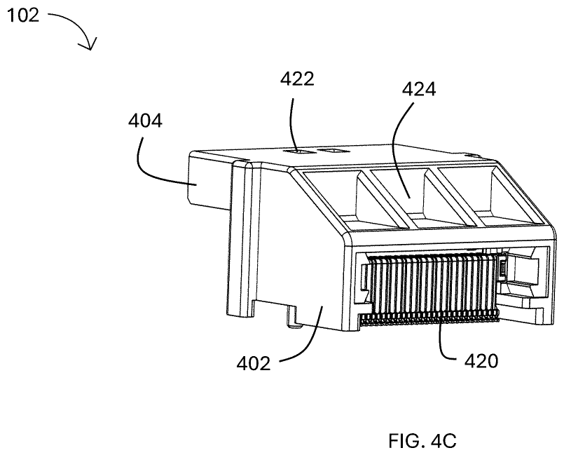

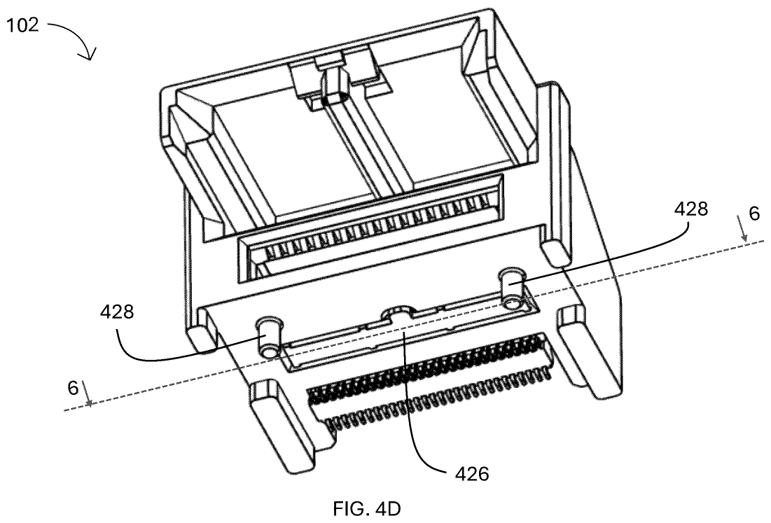

In some embodiments, the adapter 104 may include a latch 202 movably connected to the body 214 and configured for locking and unlocking from a connector (e.g., connector 102). The latch 202 may include one or more beams 206 having a proximal end 262 connected to the tongue 254 of the body 214 and a distal end 264 opposite the proximal end 262. One or more beams 206 are connected to the mating portion 224 of the body 214 of the adapter 104 at proximal ends 262. One or more beams 206 may include protrusions 208 protruding upwardly and away from the body 214 of the adapter 104 and configured for protruding into respective receivers of a mating connector (e.g., holes 422 of connector 102 in FIG. 4A). The distal ends 264 of the one or more beams 206 may be configured for releasing the protrusions from the receivers of the mating connector when pressed. As illustrated, the distal ends of the one or more beams may be joined by a bar 266. The adapter may include a channel 204 between adjacent beams 206. The adapter 104 may include a bridge 222 disposed above and connected to the rear portion 252 so as to restrain the movements of the latch 202. The bridge 222 is connected to the rear portion 252 of the body 214 and comprises a portion disposed above the rear portion 252 of the body 214. The beam 206 is movably disposed between the body 214 and the portion of the bridge 222 disposed above the rear portion 252 of the body 214.

In some embodiments, the latch 202 may include a plurality of beams 206 that extend from a proximal end of the latch 202 to a distal end of the latch 202. Each beam 206 may be a projection, extending away from the body of the adapter 104. Each beam 206 may include a protrusion 208, extending in a direction perpendicular to the beam 206. For example, the protrusion 208 may comprise a slanted surface 258. The latch 202 may include a channel 204 that extends from a proximal end 262 of the latch 202 to the distal end 264 of the latch 202. The channel 204 may be located between adjacent beams 206. The channel 204 may recess into the body 214 of the adapter 104. In the illustrated example, the adapter 104 includes a single channel 204 disposed between two beams 206. The second beam is symmetrical with the first beam. Each beam 206 includes a protrusion 208, extending away from each beam 206 and facing toward the single channel 204. The protrusion 208 may not extend beyond the edge of the channel 204.

In some embodiments, the adapter 104 may include a guide 212. In some embodiments, the guide 212 may be adjacent to the latch 202, extending from a proximal end 262 of the latch 202 to a distal end 264 of the latch 202. The guide 212 may be a projection, extending away from the body of the adapter 104. Disposed in between the guide 212 and latch 202 may be a channel 210, extending from a proximal end 262 of the latch 202 to a distal end 264 of the latch 202. The channel 210 may recess into the body 214 of the adapter 104. In the illustrated example, the adapter 104 includes a first channel 210 and a second channel 210. Each respective channel 210 is disposed between the latch 202 and a guide 212.

In some embodiments, the adapter 104 may include a plurality of arms 216. Each arm 216 may be disposed adjacent to the body 214 of the adapter 104. Each arm 216 may extend from a rear portion 252 of the body 214 and elongated in the mating direction. A first portion 272 of each arm 216 may extend beyond the rear portion 252 of the body 214 to the tongue 254 of the body 214. A second portion 274 of each arm 216 may extend along the rear portion 252 of the body 214. A transition portion 217 may join the first portion 272 of the arm 216 to a second portion 274 of the arm 216. Each arm 216 may include a projection 218. The first portion 272 of each arm 216 comprises a projection 218 protruding toward the body 214. The projection 218 may extend away from the first portion 272 of each arm 216 in a direction perpendicular to the surface of the first portion 272 of each arm 216. Each arm 216 may include an opening 220. For example, the second portion 274 of the arm 216 has an opening 220. The opening 220 may be configured to receive a fastener 228 such as a screw, bolt, pin, and/or stud, for example. For example, the adapter 104 may be fixed to a device with a fastener. In this example, the adapter 104 includes a body 214 disposed between a first arm 216 and a second arm 216. The projection 218 extends from each arm 216 and facing toward the body 214 of the adapter 104. As shown in FIG. 2C, fastener 228 may be disposed in opening 220.

In some embodiments, the adapter 104 may include a bridge 222. The bridge 222 may be configured to limit and/or restrict movement of a connector. A bridge 222 may be disposed on the rear portion 252 of the body 214 of the adapter 104. The latch 202 may be disposed between the body and the bridge 222.

In some embodiments, the adapter 104 may include projections 226. The projections 226 may extend from a bottom surface 276 of the body 214. Each projection 226 may extend away from the bottom surface 276 of the body 214. In some embodiments, the adapter 104 may include projections 218. The projections 218 may be disposed on a side surface of an arm 216 of the adapter 104. Each projection 218 may extend away from the side surface of the arm 216. In some embodiments, the adapter 104 may include projections 268. The projections 268 may extend from a proximal end 262 of the latch 202 to a distal end 264 of the latch 202.

In some embodiments, the tongue 254 of the body 214 comprises a mating portion 224 configured to engage with the device 108. The mating portion 224 of the tongue 254 may include a projection extending from a bottom surface 276 of the body 214. The rear face 256 of the mating portion 224 may be configured to abut the mating face 352 of device 108. The mating portion 224 may restrict movement of the adapter 104 when engaged with device 108. In the illustrated example, mating portion 224 may extend away from a bottom surface 276 of the body 214.

In some embodiments, the adapter 104 may include an engagement feature such as a plurality of projections 226, 218. In some embodiments, the device 108 may include an engagement feature such as a plurality of grooves 304. The plurality of grooves 304 may be disposed on a top surface of the device 108. Each groove 304 may be recessed from the top surface of device 108. The plurality of grooves 304 may extend from a portion on the top surface of the device 108 to the mating face 352 of the device 108. At least one groove 310 may be disposed at a side surface of the device 108. The at least one groove 310 may be recessed from the side surface of the device 108. The at least one groove 310 may extend from a portion on the side surface of the device 108 to the mating face 352 of the device 108. The plurality of projections 226, 218 of the adapter 104 are configured to engage with the plurality of grooves 304, 310 of the device 108. The plurality of projections and the plurality of grooves may have, but are not limited to, a snap-fit connection, sliding-fit connection, or a press-fit connection.

In the illustrated example, the plurality of projections 226 are disposed on a bottom surface 276 of the body 214, extending away from the bottom surface 276 of the body 214. A single projection 218 is located on each respective arm 216 of the adapter 104. The projection 218 is disposed on an inner surface of arm 216 and extends toward the body 214. A plurality of grooves 304 are disposed on a top surface 306 of device 108. The plurality of grooves 304 are recessed into the top surface 306. A single groove 310 is disposed on a first side surface 308 and a second side surface 308 (not shown), opposite the first side surface 308. Each respective groove 310 is recessed into the side surface 308. The plurality of projections 226 are configured to engage with the plurality of grooves 304. The projection 218 of each arm 216 is configured to engage, respectively, with the at least one groove 310 of first side surface 308, and the at least one groove 310 of the second side surface 308.

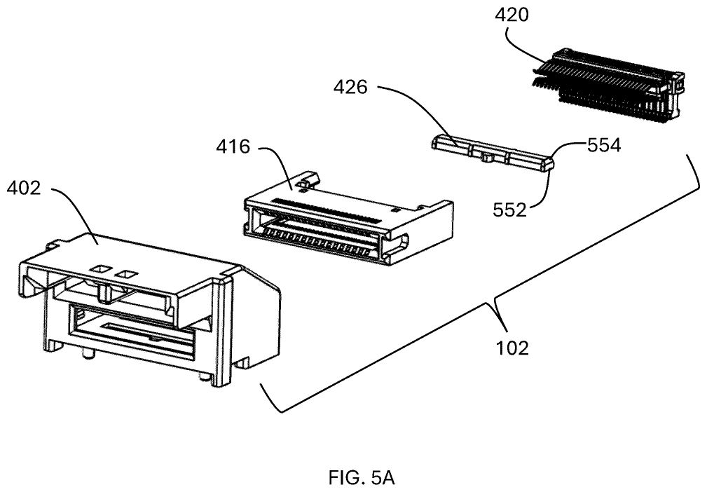

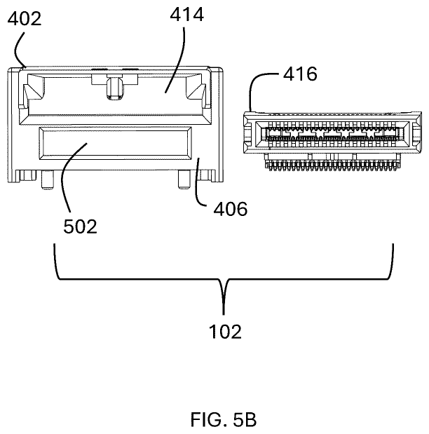

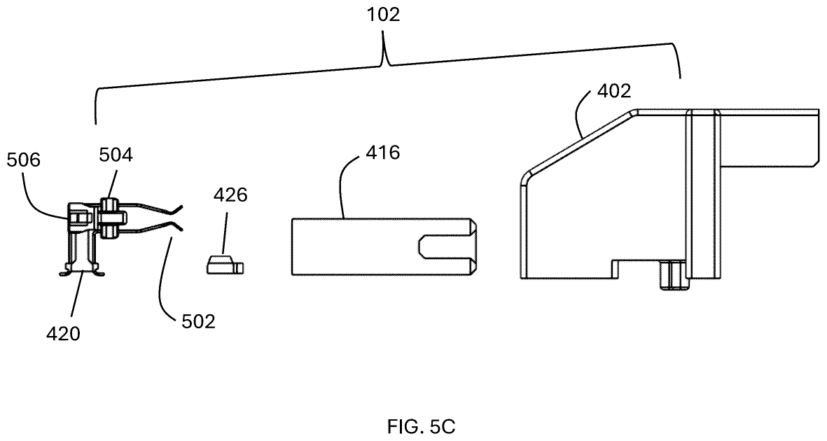

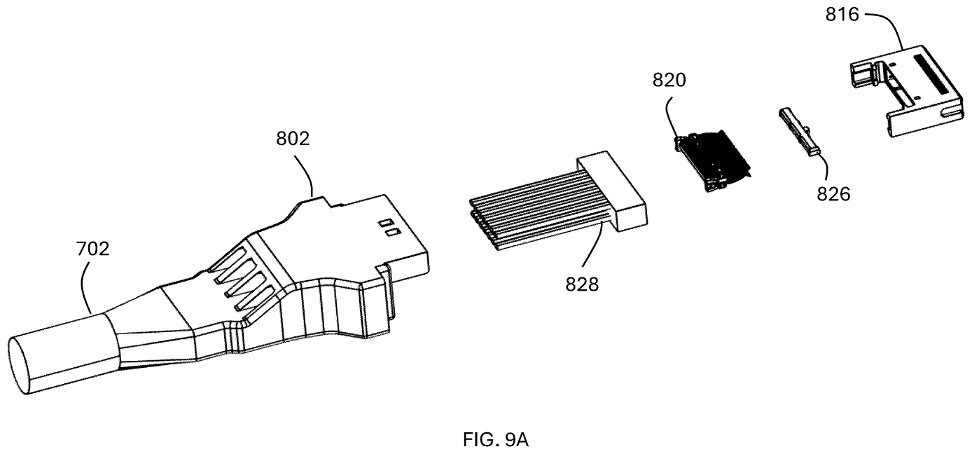

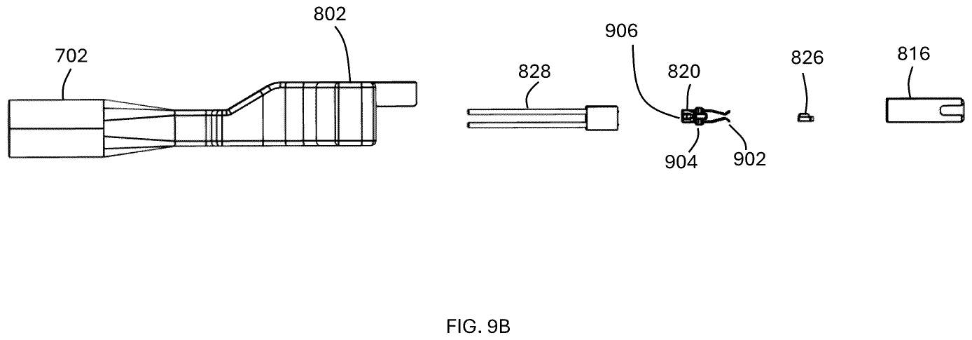

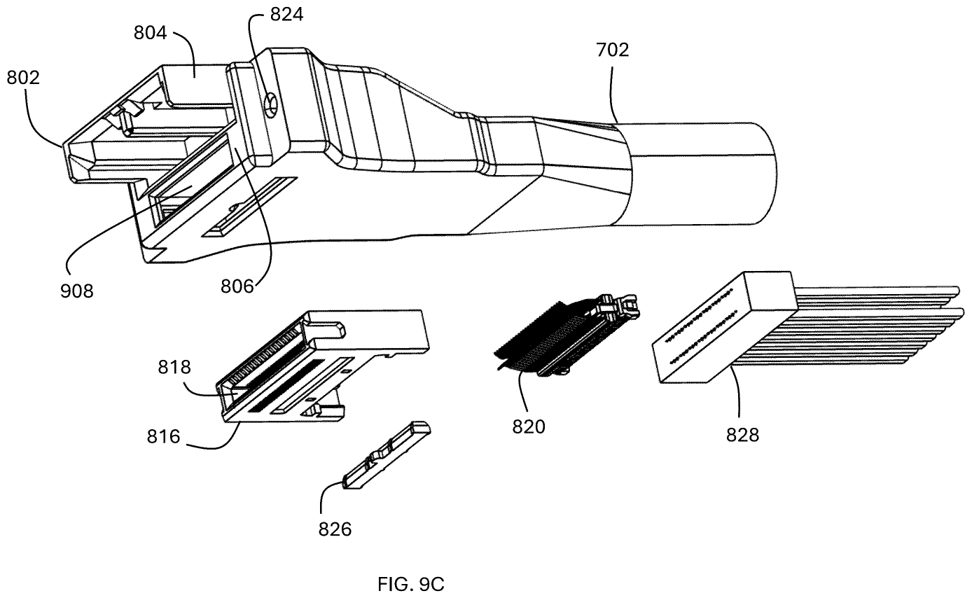

According to aspects of the present disclosure, an electrical connector (e.g., board connector 102) may include an outer housing (e.g., 402) having an upper slot (e.g., 414), a lower slot (e.g., 415) stacked below the upper slot, and an extension (e.g., 404) extending beyond the lower slot in a mating direction. The electrical connector may include an inner housing (e.g., 416) disposed in the lower slot of the outer housing. The inner housing may hold a plurality of conductive elements. A member (e.g., TPA 426) may be configured for reducing the risk of relative movements between the outer housing and the inner housing. In some embodiments, the TPA 426 may include a lower portion (e.g., 552) disposed in an opening of the outer housing and an upper portion (e.g., 554) disposed in a groove of the inner housing. The lower portion and upper portion of the member may be shaped to restrain the relative movements between the inner and outer housing. The conductive elements may be configured for mounting to a circuit board (e.g., the terminal 420 in FIG. 5A) and/or attachment with cables (e.g., terminal 820 in FIG. 9A).

FIGS. 4A-6 illustrate various views of board connector 102. The board connector 102 has engagement features configured to engage with an adapter 104 and/or a motherboard, for example. In the illustrated example, board connector 102 may be configured to engage with adapter 104 and/or PCB 106.

In some embodiments, the board connector 102 may include an extension 404. An outer housing 402 of a board connector 102 may include a body 406 and an extension 404. The body 406 may include an upper slot 414. The extension 404 may include a center projection and at least one side projection extending away from an inner surface of the extension 404. The center projection and the at least one side projection may extend from the inner surface of the extension 404 into an upper slot 414 of the body. In some embodiments, the extension 404 of the board connector 102 and the upper slot 414 of the board connector 102 may be configured to engage with the latch 202 of an adapter 104. A channel of the latch 202 may be configured to engage with the center projection of the extension 404. A channel of the latch 202 may be configured to engage with at least one side projection of the extension 404.

In the illustrated example, outer housing 402 may include an extension 404 and a body 406. Body 406 may include an upper slot 414 as shown in FIG. 4B. Extension 404 may include at a first side projection 410, a second side projection 410, and a center projection 412 extending away from an inner surface of the extension 404. The first side projection 410, second side projection 410, and center projection 412 may extend from the surface of extension 404 into upper slot 414. The first side projection 410, second side projection 410, and center projection 412 may be elongated in the mating direction and protruding into the upper slot. In some embodiments, the extension 404 and upper slot 414 may be configured to engage with latch 202 of the adapter 104. In some embodiments, channel 204 of latch 202 may be configured to engage with center projection 412. In some embodiments, at least one channel 210 of latch 202 may engage with at least one side projection 410.

FIG. 4B is a front view of the board connector of FIG. 4A, according to some embodiments. In some embodiments, the board connector 102 may include an engagement feature such as an inner housing. The body 406 may include a lower slot 415, as shown more clearly in FIG. 5B. The inner housing may be embedded into the lower slot 415 of the body of the board connector 102. The inner housing may extend from a proximal end of the body to a distal end of the body. The inner housing may include a slot. A plurality of conductive elements may be disposed in the slot of the inner housing. The plurality of conductive elements may include a plurality of conductive elements. The plurality of conductive elements may secured in the inner housing. The connector may include a terminal position assurance (TPA). The TPA may restrain the relative movements between the inner housing and the outer housing. In the illustrated example, inner housing 416 may be embedded in lower slot 415 (not pictured) of body 406. Inner housing 416 may extend from a proximal end of body 406 to a distal end of body 406. Inner housing 416 may include slot 418. A plurality of conductive elements (e.g., the terminal 420) embedded in TPA 426. Conductive elements (e.g., the terminal 420) and TPA 426 may be disposed in the slot 418 of inner housing 416. In some embodiments, inner housing 416 may be configured to engage with the card edge 302 of device 108.

FIG. 4C is a rear perspective view of the board connector of FIG. 4A, according to some embodiments. In some embodiments, the distal end of the outer housing may include at least one recess. The outer housing may include at least one hole. In the illustrated example, the distal end of the outer housing 402 may include a first recess 424, a second recess 424, and a third recess 424. A top surface of the proximal end of the outer housing 402 may include a first hole 422 and a second hole 422. For example, the extension comprises a pair of holes 422 and a pair of protrusions protruding downwardly and adjacent respective ones of the pair of holes 422; and the center projection 412 is disposed between the pair of protrusions. The pair of protrusions are disposed on opposite sides of the projection 412 disposed in the channel 204 between the first and second beams 206 of the latch 202 of the adapter 104. The first and second beams 206 of the latch 202 of the adapter 104 comprise protrusions 208 and abut against respective ones of the pair of protrusions disposed on the opposite sides of the projection 412. The protrusions 208 of the first and second beams 206 protrudes toward respective ones of the pair of holes 422 of the extension 404 of the outer housing 402 of the connector 102.

FIG. 4D is a bottom perspective view of the board connector of FIG. 4A, according to some embodiments. In some embodiments, the board connector 102 may include an engagement feature such as a post. The post may extend in a direction away from a bottom surface of the body. The post may be configured to engage with a motherboard. The shape of the post may include, but is not limited to, a square, cylinder, circle, rectangle, and/or a triangle. In the illustrated example, a bottom surface of body 406 may include a post 428, extending in a direction away from the bottom surface of the body 406. In some embodiments, post 428 may be configured to engage with PCB 106. The outer housing 402 comprises a side extension configured to abut a mating face 352 of a mating device 108.

FIG. 5A is a partially exploded perspective view of the board connector of FIG. 4A, according to some embodiments. In some embodiments, a proximal end of inner housing 416 may be configured to engage with a distal end of outer housing 402. In some embodiments, a proximal end of TPA 426 may be configured to engage with a distal end of inner housing 416. In some embodiments, a proximal end of terminal 420 may be configured to engage with a distal end of TPA 426.

FIG. 5B is a front view of the board connector of FIG. 5A, according to some embodiments. In some embodiments, the body of outer housing of the board connector 102 may include an upper slot 414 and a lower slot 415. In some embodiments, the inner housing may be disposed in the lower slot 415. In the illustrated example, body 406 of outer housing 402 may include an upper slot 414 and a lower slot 415. Inner housing 416 may be disposed in lower slot 415.

FIG. 5C is a side view of the board connector of FIG. 5A, according to some embodiments. In some embodiments, the board connector 102 may include a plurality of conductive elements. The plurality of conductive elements may comprise a mating end at the proximal end of the plurality of conductive elements. The plurality of terminal may comprise a tail portion at the distal end of the plurality of conductive elements. The plurality of conductive elements may comprise an intermediate portion disposed in between the tail portion and the mating end of the plurality of conductive elements. In the illustrated example, terminal 420 may comprise a mating end 502 at the proximal end of terminal 420. Terminal 420 may comprise a tail portion 506 at the distal end of terminal 420. The mating end 502 is disposed in the slot 418 of the inner housing 416. Terminal 420 may comprise an intermediate portion 504 disposed in between the mating end 502 and the tail portion 506.

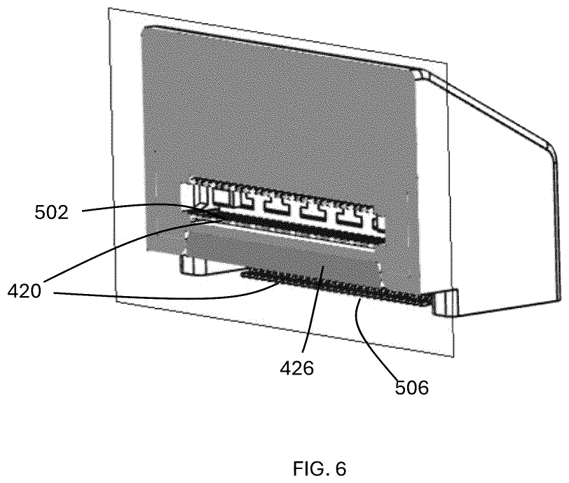

FIG. 6 is a cross-sectional perspective view of the board connector of FIG. 4A along a line marked “6-6” in FIG. 4D, according to some embodiments. The plurality of conductive elements may be secured in the inner housing. The connector may include a terminal position assurance (TPA). The TPA may restrain the relative movements between the inner housing and the outer housing. In the illustrated example, a plurality of conductive elements (for example, terminal 420) are embedded in TPA 426. The mating end 502 of terminal 420 is disposed on a first side of TPA 426 and the tail portion 506 of terminal 420 is disposed on a second side of TPA 426. The tail portions 506 of the terminal 420 comprises surfaces configured for mounting to a circuit board and extending in parallel to the mating direction.

FIG. 7 is a partially exploded perspective view of an electronic system, according to some embodiments. In some embodiments, cable connector 700 may be configured to engage with adapter 104. In some embodiments, cable connector 700 may be configured to engage with device 108. In some embodiments, cable connector 700 may be configured to engage a cable, not shown in the illustrated example. The cable may engage with a cable tail 702 of cable connector 700. Cable connector 700 includes a plurality of cables comprising wires attached to the tail portions 506 of the terminal 420. The cable may be, but is not limited to, a fiber optic cable, USB cable, HDMI cable, twisted pair cable, and/or a coaxial cable. In the illustrated example, adapter 104 may be configured to engage with DEVICE 108. Adapter 104 is disposed on DEVICE 108, where card edge 302 of DEVICE 108 may align with the latch 202 of the adapter 104. Adapter 104 may be configured to engage with cable connector 700. Adapter 104 may enable a direct connection between cable connector 700 and DEVICE 108.

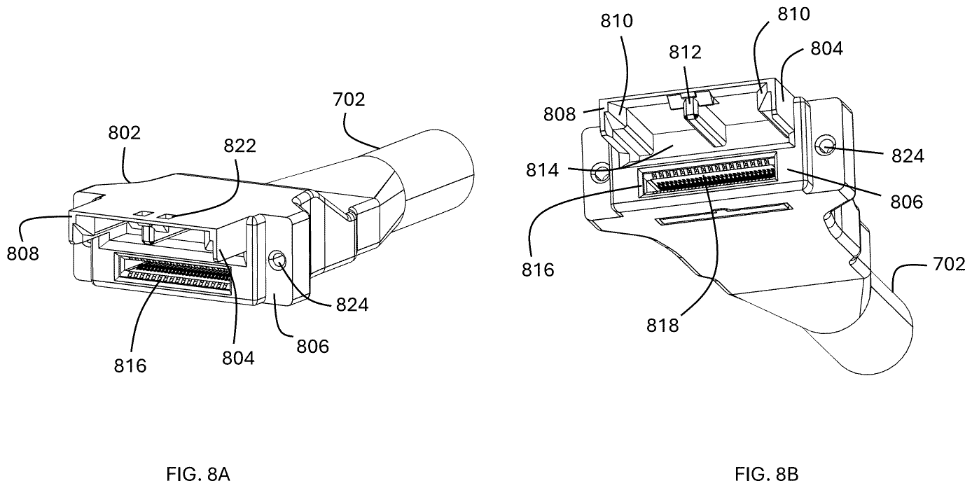

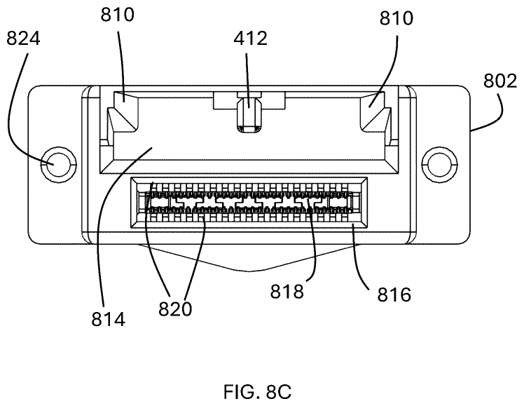

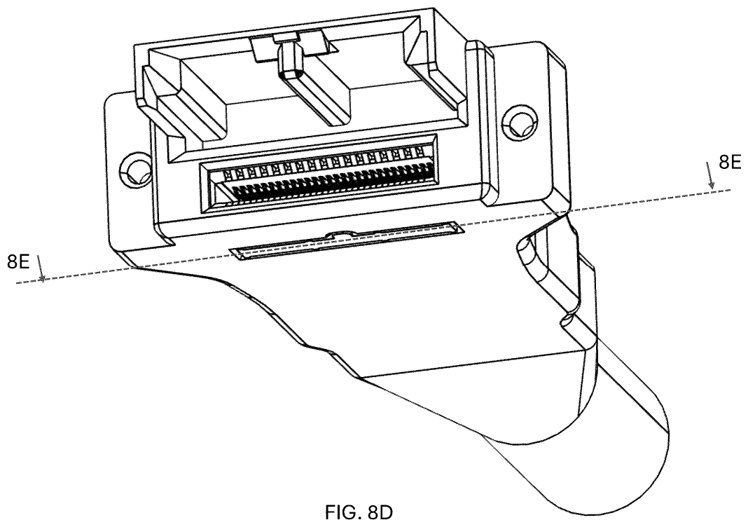

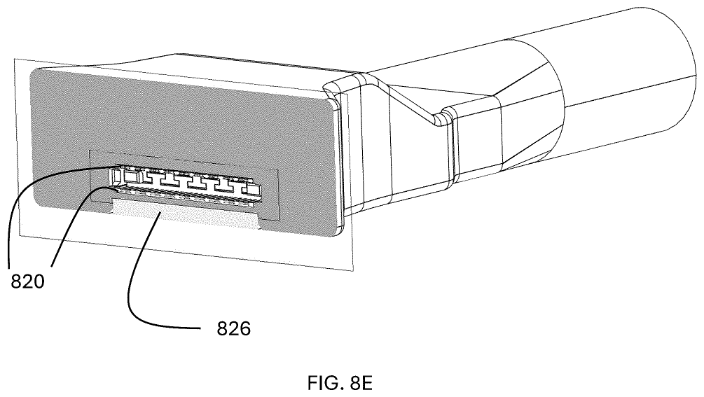

FIG. 8A is a front perspective view of a cable connector of the electronic system of FIG. 7, according to some embodiments. The cable connector has multiple engagement features to engage an adapter and/or a device, for example. In some embodiments, the cable connector may include an engagement feature such as an extension 804. An outer housing of a cable connector may include a body and an extension 804. The body may include an upper slot 814. The extension 804 may include a center projection and at least one side projection extending away from an inner surface of the extension 804. The center projection and the at least one side projection may extend from the inner surface of the extension 804 into an upper slot 814 of the body. In some embodiments, the extension 804 of the cable connector and the upper slot 814 of the board connector 102 may be configured to engage with the latch 202 of an adapter 104. A channel of the latch 202 may be configured to engage with the center projection of the extension 804. A channel of the latch 202 may be configured to engage with at least one side projection of the extension 804.

In the illustrated example, outer housing 802 may include extension 804 and body 806. Body 806 may include an upper slot 814 as shown in FIG. 8B. Extension 804 may extend away from a proximal end of the body 806 to a proximal end of the extension 804. Extension 804 may include at a first side projection 810, a second side projection 810, and a center projection 812 extending away from an inner surface of the extension 804. The first side projection 810, second side projection 810, and center projection 812 may extend from the surface of extension 804 into upper slot 814. In some embodiments, although not shown in the illustrated example, the extension 804 and upper slot 814 may be configured to engage with latch 202 of the adapter 104. In some embodiments, although not shown in the illustrated example, channel 204 of latch 202 may be configured to engage with center projection 812. In some embodiments, although not shown in the illustrated example, at least one channel 210 of latch 202 may engage with at least one side projection 410.

In some embodiments, the cable connector may include an engagement feature such as a fastening assembly. The body of a cable connector may include a plurality of fastening openings. The openings may be configured to receive a fastener such as a screw, bolt, pin, and/or stud, for example. For example, the cable connector may be affixed to an adapter 104 with a fastener. In the illustrated example, body 806 of cable connector 700 incudes a plurality of openings 824. Each arm 216 of adapter 104 includes an opening 220. Adapter 104 may be configured to engage with cable connector 700, where extension 804 may align with latch 202.

In some embodiments, the outer housing may include at least one hole. In the illustrated example, a top surface of the proximal end of the outer housing 802 may include a first hole 822 and a second hole 822.

FIG. 8B is a front, bottom perspective view of the cable connector of FIG. 8A, according to some embodiments. In some embodiments, the cable connector may include an engagement feature such as an inner housing. The body may include a lower slot 908, as shown more clearly in FIG. 9C. The inner housing may be embedded into the lower slot 908 of the body of the cable connector. The inner housing may extend from a proximal end of the body to a distal end of the body. The inner housing may include a slot. A plurality of conductive elements may be disposed in the slot of the inner housing. In the illustrated example, inner housing 816 may be embedded in lower slot 908 of body 806. Inner housing 816 may extend from a proximal end of body 806 to a distal end of body 806. Inner housing 816 may include slot 818. In some embodiments, although not shown in the illustrated example, inner housing 816 may be configured to engage with the card edge 302 of DEVICE 108.

FIG. 8C is a front view of the cable connector of FIG. 8A, according to some embodiments. In some embodiments, a plurality of conductive elements may be disposed in the slot of the inner housing. In the illustrated example, inner housing 816 may include a plurality of conductive elements (e.g., a terminal 820).

FIG. 8D is a bottom perspective view of the cable connector of FIG. 8A, according to some embodiments. FIG. 8E is a cross-sectional perspective view of the cable connector of FIG. 8A along a line marked “8-8” in FIG. 8D, according to some embodiments. The plurality of conductive elements may be secured in the inner housing. The connector may include a terminal position assurance (TPA). The TPA may restrain relative movements between the inner housing and the outer housing. In the illustrated example, a plurality of conductive elements (e.g., the terminal 820) are embedded in TPA 826. The terminal 820 and TPA 826 may be disposed in the slot 818 of inner housing 816.

FIG. 9A is a partially exploded perspective view of the cable connector of FIG. 8A, according to some embodiments. In some embodiments, a distal end of the inner housing 816 may be configured to engage with a proximal end of TPA 826. In some embodiments, a distal end of TPA 826 may be configured to engage with a proximal end of terminal 820. In some embodiments, a distal end of terminal 820 may be configured to engage with a proximal end of cable 828. Cable 828 may be any conductive wire. In some embodiments, a distal end of cable 828 may be configured to engage with a proximal end of the outer housing.

FIG. 9B is a partially exploded side view of the cable connector of FIG. 8A, according to some embodiments. The plurality of conductive elements may comprise a mating end at the proximal end of the plurality of conductive elements. The plurality of conductive elements may comprise a tail portion at the distal end of the plurality of conductive elements. The plurality of conductive elements may comprise an intermediate portion disposed in between the tail portion and the mating end of the plurality of conductive elements. In the illustrated example, terminal 820 may comprise a mating end 902 at the proximal end of terminal 820. Terminal 820 may comprise a tail portion 906 at the distal end of terminal 820. Terminal 820 may comprise an intermediate portion 904 disposed in between the mating end 902 and the tail portion 906.

FIG. 9C is a partially exploded, front, bottom perspective view of the cable connector of FIG. 8A, according to some embodiments.

In some embodiments, the body of outer housing of the cable connector may include an upper slot 814 and a lower slot 908. In some embodiments, the inner housing may be disposed in the lower slot 908. In the illustrated example, body 806 of outer housing 802 may include an upper slot 814 and a lower slot 908. Inner housing 816 may be disposed in lower slot 908.

A method of operating an adapter configured to mechanically support a device when the device is connected to an electrical connector includes: providing a device comprising a top, bottom, side joining the top and bottom, and a mating face at a front; and installing the adapter on the device comprising disposing a body of the adapter on the top of the device such that a portion of the body of the adapter extends beyond the mating face of the device.

The body of the adapter comprises a rear portion and a tongue extending from the rear portion; and the tongue comprises the portion of the body of the adapter that extends beyond the mating face of the device.

The adapter comprises an arm connected to the rear portion of the body, each of the body and arm comprising one or more projections; each of the top and side of the device comprising one or more grooves; and installing the adapter on the device comprising disposing the one or more projections of the body and arm of the adapter in the one or more grooves of the top and side of the device, respectively.

The method further includes: inserting a fastener through an opening of the arm of the adapter into an opening at the top of the device.

Installing the adapter on the device comprises: engaging a rear face of the portion of the body of the adapter that extends beyond the mating face of the device with the mating face of the device.

The device comprises a card edge extending beyond the mating face of the device and parallel to the portion of the body of the adapter that extends beyond the mating face of the device.

The method further includes: providing a connector comprising: an outer housing having an upper slot, a lower slot, and an extension extending beyond the lower slot in a mating direction, and an inner housing disposed in the lower slot of the outer housing; and mating the device with the connector comprising inserting the tongue of the adapter into the upper slot of the outer housing of the connector.

The adapter comprises first and second beams having proximal ends connected to the tongue of the body and distal ends disposed above the rear portion of the body, and a channel between the first and second beams; the extension of the connector comprising a projection elongated in the mating direction and protruding into the upper slot; and inserting the tongue of the adapter into the upper slot of the outer housing of the connector comprises: inserting the projection of the extension of the outer housing of the connector into the channel between the first and second beams of the adapter.

The first and second beams of the adapter each comprises a protrusion protruding upwardly; inserting the tongue of the adapter into the upper slot of the outer housing of the connector comprises: at least partially disposing the protrusions of the first and second beams of the adapter in respective holes at the top of the extension of the outer housing of the connector.

The method further includes: unmating the device from the connector comprising: pressing the first and second beams of the adapter so as to disengage the protrusions of the first and second beams from the respective holes at the top of the extension of the outer housing of the connector.

In some embodiments, a connector housing such as the inner housing and outer housing may be dielectric members molded from a dielectric material such as plastic or nylon. Examples of suitable materials include, but are not limited to, liquid crystal polymer (LCP), polyphenylene sulfide (PPS), high temperature nylon or polyphenylene oxide (PPO) or polypropylene (PP). Other suitable materials may be employed, as aspects of the present disclosure are not limited in this regard.

In some embodiments, conductive elements may be made of metal or any other material that is conductive and provides suitable mechanical properties for conductive elements in an electrical connector. Phosphor-bronze, beryllium copper and other copper alloys are non-limiting examples of materials that may be used. The conductive elements may be formed from such materials in any suitable way, including by stamping and/or forming.

Various aspects of the present invention may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Also, the invention may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

All definitions, as defined and used herein, should be understood to control over dictionary definitions, definitions in documents incorporated by reference, and/or ordinary meanings of the defined terms.

Terms signifying direction, such as “up” and “down” or front and back were used in connection with some embodiments. These terms were used to signify direction based on the orientation of components illustrated or connection to another component, such as a surface of a printed circuit board to which a termination assembly is mounted or the mating face of a connector. It should be understood that electronic components may be used in any suitable orientation. Accordingly, terms of direction should be understood to be relative, rather than fixed to a coordinate system perceived as unchanging, such as the earth's surface.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

The indefinite articles “a” and “an,” as used herein in the specification and in the claims, unless clearly indicated to the contrary, should be understood to mean “at least one.”

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified.

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

Also, the phraseology and terminology used herein are for the purpose of description and should not be regarded as limiting. The use of “including,” “comprising,” “having,” “containing,” or “involving,” and variations thereof herein, is meant to encompass the items listed thereafter (or equivalents thereof) and/or as additional items.

What is claimed is:

1. An adapter configured for attachment to a device so as to mechanically support the device when the device is connected to an electrical connector, the adapter comprising:
a body comprising a rear portion configured for engaging a top of the device and a tongue extending from the rear portion;
a latch comprising a beam having a proximal end connected to the tongue of the body and a distal end opposite the proximal end; and
an arm connected to the rear portion of the body and configured for attachment to a corner of the device.

2. The adapter of claim 1, further comprising:
a bridge connected to the rear portion of the body and comprising a portion disposed above the rear portion of the body,
wherein the beam is movably disposed between the body and the portion of the bridge disposed above the rear portion of the body.

3. The adapter of claim 2, wherein:
the beam comprises a first portion and a second portion disposed closer to the portion of the bridge disposed above the rear portion of the body than the first portion; and
the second portion is t-shaped.

4. The adapter of claim 3, wherein:
the beam is a first beam;
the latch comprises a second beam having a proximal end connected to the tongue of the body and a distal end opposite the proximal end, and a channel between the first beam and the second beam;
the second beam is symmetrical with the first beam; and
the latch comprises a bar connecting the distal ends of the first and second beams.

5. The adapter of claim 1, wherein:
the arm comprises a first portion extending beyond the rear portion of the body, and a second portion having an opening configured to receive a fastener.

6. The adapter of claim 5, wherein:
the arm comprises a transition portion joining the first portion and the second portion; and
the first portion of the arm comprises a projection protruding toward the body.

7. The adapter of claim 5, wherein:
the tongue of the body comprises a mating portion configured to engage with the device.

8. An electrical connector comprising:
an outer housing comprising an upper slot, a lower slot, and an extension extending beyond the lower slot in a mating direction;
an inner housing disposed in the lower slot of the outer housing and comprising a slot; and
a plurality of conductive elements disposed in the inner housing, each of the plurality of conductive elements comprising a mating end disposed in the slot of the inner housing, a tail portion, and an intermediate portion between the mating end and the tail portion.

9. The electrical connector of claim 8, wherein:
the extension comprises at least one projection elongated in the mating direction and protruding into the upper slot.

10. The electrical connector of claim 9, wherein:
the extension comprises a pair of holes and a pair of protrusions protruding downwardly and adjacent respective ones of the pair of holes; and
the at least one projection is disposed between the pair of protrusions.

11. The electrical connector of claim 8, wherein:
the tail portions of the plurality of conductive elements comprises surfaces configured for mounting to a circuit board; and
the surfaces of the tail portions of the plurality of conductive elements extending in parallel to the mating direction.

12. The electrical connector of claim 8, further comprising:
a plurality of cables comprising wires attached to the tail portions of the plurality of conductive elements.

13. The electrical connector of claim 8, further comprising:
a member comprising a lower portion disposed in an opening of the outer housing and an upper portion disposed in a groove of the inner housing.

14. The electrical connector of claim 13, wherein:
the upper portion of the member is shaped to restrain relative movements between the inner housing and the outer housing.

15. The electrical connector of claim 13, wherein:
the outer housing comprises a side extension configured to abut a mating face of a mating device.

16. An electronic system comprising:
a device comprising a mating face and a card edge adjacent the mating face; and
an adapter fixedly disposed on the device and comprising a mating portion having a rear face abutting the mating face of the device.

17. The electronic system of claim 16, wherein the adapter further comprises:
a body comprising a tongue comprising the mating portion, and a rear portion; and
an arm connected to the rear portion and attached to a corner of the device,
wherein the arm engages with a top and a side of the device.

18. The electronic system of claim 16, further comprising:
a fastener extending through an opening of the adapter into an opening of the device.

19. The electronic system of claim 17, wherein:
the arm comprises a projection protruding toward the body;
the body comprises a projection protruding downwardly; and
the device comprises:
a first groove recessed from a side of the device and configured to receive the projection of the arm, and
a second groove recessed from a top of the device and configured to receive the projection of the body.

20. The electronic system of claim 17, wherein the adapter further comprises a latch comprising:
first and second beams connected to the mating portion of the body of the adapter at proximal ends and comprising first and second projections upwardly, respectively, and
a channel between the first beam and the second beam.
